(19) United States
(12) Patent Application Publication
(10) Pub. No.: US 2026/0048888 A1
(43) Pub. Date: Feb. 19, 2026

(54) A LABEL APPLICATION MACHINE

(71) Applicant: Dover Europe Sàrl, Vernier (SE)

(72) Inventor: Jonas Södergård, Vastra Frolunda (SE)

(21) Appl. No.: 19/100,464

(22) PCT Filed: Aug. 1, 2023
(86) PCT No.: PCT/EP2023/071306

§ 371 Date: Jan. 31, 2025

(30) Foreign Application Priority Data
Aug. 1, 2022 (SE) 2250937-6
Aug. 1, 2022 (SE) 2250938-4
Aug. 1, 2022 (SE) 2250939-2
Aug. 1, 2022 (SE) 2250940-0
Aug. 1, 2022 (SE) 2250941-8
Aug. 1, 2022 (SE) 2250942-6
Aug. 1, 2022 (SE) 2250943-4
Aug. 1, 2022 (SE) 2250944-2

(51) Int. Cl. B65C 9/36; B25J 15/06; B65C 1/04; B65C 9/42

(52) U.S. Cl. CPC B65C 9/36; B65C 1/04; B65C 9/42; B25J 15/0683

(57) ABSTRACT

The specification relates to a labelling machine configured to apply a label on an object. The labelling machine comprising: an arm mechanism; a label pad attached to a first end of said arm mechanism; an actuator connected to a first end of said arm mechanism to provide rotational movement; a control system configured to control the movement and position of said arm mechanism and the label pad; and an air flow generator. The labelling machine further comprises a drive shaft connected to said actuator and configured to be rotated about the drive shaft's longitudinal axis; a second end of the arm mechanism is connected to said drive shaft, such that the longitudinal axis of the drive shaft and the arm mechanism are perpendicular to one another; and an air flow channel extends from the air flow generator via the drive shaft, through the arm mechanism to the label pad.

### TECHNICAL FIELD

The disclosure relates generally to applicator machine and in particular aspects, the disclosure relates to a label applicator machine for applying labels on an object. The machine of disclosure can cooperate with an industrial printer in general and label printers, in particular.

### BACKGROUND

A labelling machine is utilized for applying labels to packaging or products. Some labelling machines can also produce labels in collaboration with a label printing machine.

The most common type of automatic label applicator is based on linear movement, allowing it to apply labels from the side or top of objects, known as a tamp applicator. The longer the applicator stroke, the greater the allowable variation in the dimensions of the object. Another common type of automatic label applicator is the rotating arm type, which can apply labels to the front, right, left, top, and rear sides of an object, known as a wipe applicator. This type of applicator can apply multiple labels to different sides of an object without stopping it. It can also apply a label around a corner to make it readable from two sides.

Both types of label applicators are typically activated using compressed air, although electrical activation is becoming more common. Additionally, both types of label applicators usually employ vacuum (generated by compressed air) or suction (generated by fans) to hold the label on the label pad during application. When fans are used, they are traditionally located close to the label on the applicator pad, necessitating electrical wiring to be routed through the rotation point to the label pad. This setup exposes the fan to wear and increases the moving mass.

Currently, there is a growing focus on sustainability, leading to a demand for compressed air-free solutions. The increasing need for fast and reliable solutions calls for reduced moving mass and fewer components prone to wear. Designing a rotating arm label applicator, presents additional challenges in preparing it for various applications. Both linear and wipe applicator systems may have different stroke lengths or use different arm lengths/rotation radii.

Generally, a wipe applicator is a type of label applicator system that is designed to apply labels on multiple sides of an object, including the front, right, left, top, and rear sides. The term “wipe” refers to the motion of the label applicator as it applies the label by wiping it onto the object's surface.

The wipe applicator typically consists of an arm or mechanism that holds the label and moves it in a turning or rotating motion to apply the label onto the desired side of the object. This type of applicator allows for versatile label placement and can even apply labels around corners, making them readable from multiple angles.

To ensure effective label application, the wipe applicator needs to approach the label pad from one end, usually referred to as the “wrist,” and move towards the other end, known as the “fingertips.” This movement allows for a smooth application process. If the wipe applicator were to approach the object with the “fingertips” first, there would be a risk of the label pad getting stuck in the object, leading to a jam.

Wipe applicators are commonly used in industries where labels need to be applied to various sides of products or packages. They offer flexibility and versatility in labeling applications, allowing for efficient and accurate labeling of objects from different orientations and angles.

Furthermore, for the wipe applicator system, the orientation and location of its axis of rotation must vary to accommodate different scenarios. One of the main challenges of a wipe applicator system is to handle a wide range of labelling scenarios effectively. Another challenge faced by automatic label applicators is the ability to handle uneven or skewed surfaces. This is typically achieved using a joint mechanism. In a wipe applicator, which applies labels as the object passes by, the joint only needs to provide for an axis that allows the label pad to move around it and can be positioned close to the label pad. The joint should allow the label pad to follow the object's surface during application while returning to a predictable “home” position when not in use, ensuring consistent feeding of new labels onto the label pad. The joint should be lightweight, durable, easy to produce, and cost-effective.

If a suction fan is located in the main body of the applicator, the joint should facilitate low-resistance transportation of air without leakage. In the case where the applicator arm is positioned at the centre of the label pad, the joint movement could be symmetrical.

Systems that print and apply labels, also known as print and apply systems, have various requirements. Two common and seemingly contradictory requirements are as follows:
1. The system/solution should be capable of applying printed labels to different sides of an object.
2. The selection of the right system/solution should be straightforward, without excessive versions and combinations.

One commonly adopted approach to address requirement 1 is to offer two versions of the print and apply system: one for the right side and one for the left side. This effectively doubles the number of versions, making it challenging to fulfil requirement 2. However, it effectively meets requirement 1. Label applicators often exhibit asymmetry, meaning they excel at applying labels to a specific side or corner of the object when the object travels in a particular direction but not in the opposite direction.

The wipe type of label applicator demonstrates this asymmetry most prominently. In some designs, the labelling object approaches the label pad from the joint to the outer end of the label applicator for smooth application. If the labelling object approaches the outer end first, there is a high risk of the label pad getting stuck in the object, causing the entire system to lock up and leading to jamming of the labelling object. Asymmetry is less apparent in the common linear type applicators, where the label pad approaches the labelling object perpendicularly with the “flat palm”/applicator first, allowing the labelling object to approach from any direction.

### SUMMARY

The present disclosure herein affords many advantages, of which a non-exhaustive list of examples follows.

The arrangements disclosed and described in the following provide solutions for previously mentioned challenges and provide several advantages, such as:
a light yet strong solution well suited for fast activation is provided;
moving mass of the applicator pad can be reduced;
bendable or twistable wiring to power the fan(s) is eliminated;
the fan used is exposed to less wear; and
the applicator arm can rotate 360°with uninterrupted airflow.

According to a first aspect, a labelling machine configured to apply a label on an object is provided. The labelling machine comprising: an arm mechanism; a label pad mechanically attached to a first end of said arm mechanism, designed to retain and dispense a label; an actuator operatively connected to said arm mechanism, providing a controlled rotational movement; a control system for regulating the movement and positioning of said arm mechanism and the label pad; and a device for generating an air flow. The labelling machine further comprises a drive shaft connected to said actuator and configured to be rotated along drive shaft's longitudinal center axis; the arm mechanism, at a second end, connected to said drive shaft, such that the longitudinal axis of the drive shaft and the arm mechanism are substantially perpendicular; and an air flow channel extends from the device for generating air flow via the drive shaft, through the arm mechanism to the applicator pad.

According to a second aspect of the disclosure a print and apply system comprising a label printer and a labelling machine as disclosed is provided.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples. Reference is made to the attached drawings, wherein elements having the same reference number designation may represent like elements throughout.

FIG. 1 depicts schematically a cross sectional view of an exemplary label applicator in which the teachings of the present disclosure can be implemented;

FIGS. 2a and 2b illustrate an exemplary housing as part of the label applicator according to FIG. 1;

FIG. 3 is a schematic view of an exemplary print and apply system comprising a label applicator as specified in the present disclosure;

FIG. 4 depicts schematically a partly cross-sectional view from above of another exemplary label applicator in which the teachings of the present disclosure can be implemented;

FIG. 5 illustrates schematically a partly a cross-sectional side view of the label applicator of FIG. 4 from one side;

FIG. 6 is a schematic representation of the rotation of the tubular arm around its center axis;

FIG. 7 is a schematic view of operation of an exemplary print and apply system comprising a label applicator as specified in the present disclosure;

FIGS. 8a to 8d are crosse-sectional views of an exemplary wrist joint;

FIGS. 9 to 14 are schematic views of operation of exemplary print and apply systems comprising a label applicator as specified in the present disclosure; and

FIG. 15 is a schematic block diagram of a controller.

### DETAILED DESCRIPTION

The term “industrial printer”, also known as an “industrial-grade printer”, as used herein, may refer to a type of printer specifically designed for heavy-duty printing tasks in industrial environments. These types of printers are built to handle large volumes of printing, often with high-speed and precision, and are capable of printing on various materials such as paper, cardboard, labels, plastics, and metals. The industrial printers, as referred to herein, may commonly be used in sectors like manufacturing, logistics, packaging, and retail, where there is a need for efficient and reliable printing solutions. They are typically more robust and durable compared to standard office printers, as they are required to withstand harsher conditions and extended operation periods.

Depending on the specific application, industrial label printers may utilize different printing technologies. Some common types may include:
Thermal Transfer Printers (TTP): These printers use heat to transfer ink from a ribbon onto the printing material, such as labels or tags. They are widely used for barcode printing and labeling applications.
Direct Thermal Printers (DTP): These printers use heat-sensitive paper that turns black when exposed to heat, creating the desired print. They are commonly used for printing receipts, shipping labels, or temporary labels.
Inkjet Printers: Industrial inkjet printers use inkjet technology to propel tiny droplets of ink onto the printing surface. They can print high-resolution images and are suitable for printing on various materials, including paper, plastics, and metals.
Laser Printers: Industrial laser printers use laser technology to create the desired print. They are often used for high-speed and high-volume printing applications, such as printing documents or product packaging.

Industrial printers may also incorporate additional features, such as advanced connectivity options, rugged enclosures, automatic label applicators, or integrated systems for data management and control. These features enhance their productivity, efficiency, and integration with other industrial processes.

The term “label”, as used herein, may include an information carrier media which can be made of several types of materials, depending on the specific requirements and application. Some common materials used for printer labels may for example include (but not limited to): paper, synthetic materials, cardstock, clear and transparent materials, thermal labels, and specialty materials.

The term “label backing paper” or “liner”, as used herein, may refer to a carrier on which labels are arranged and may comprise different materials.

According to the first aspect as disclosed herein and described in more detail, a fan is used to generate an air suction to retain a label on the label pad. The fan is located in a main body of the Wipe applicator where it is stationary. The fan, for example a centrifugal fan, is connected to a rotating hallow main shaft and rotates through for example sealed bearings, to prevent leakage. The main shaft can be connected to a hollow “elbow-shaped” joint (elbow), which continues with a tubular arm and connects to a hollow “wrist-shape” (wrist) connection, which connects to the applicator pad, which distributes the air and holds the label.

The hollow design allows for a light yet strong solution well suited for fast activation. Having the fan in the stationary main body (housing) reduces the moving mass. The solution needs no bendable or twistable wiring to power the fan(s). The solution exposes the fan to significantly less wear since it doesn't collide with the application target for every label applied. The solution allows the applicator arm to rotate 360° with uninterrupted airflow.

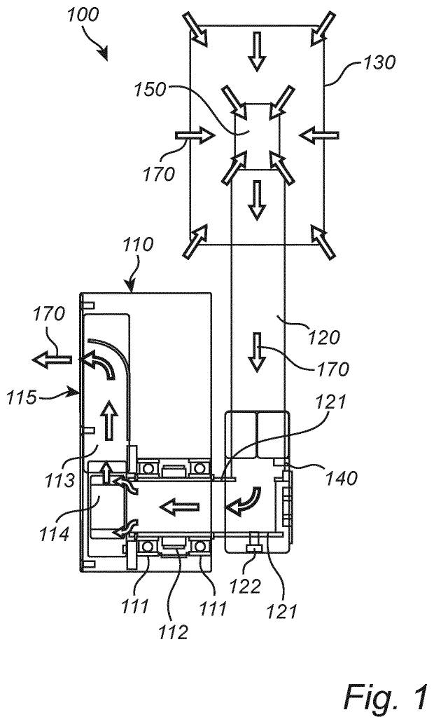

FIG. 1 illustrates a cross-sectional view, from above, of an exemplar applicator assembly 100, of so-called wipe applicator type, incorporating teachings of the present disclosure. The applicator assembly 100 comprises: a housing 110, a substantially tubular shaped arm 120 or a tubular arm mechanism, and an applicator pad 130. The applicator pad 130 is mechanically attached to the tubular arm 120 through a connector or joint 150. The tubular arm 120 is mechanically and rotatably attached to the housing 110 by means of a hollow coupling arrangement 140, which is mechanically attached to a hollow shaft or tube 121. The tube 121 extends inside the housing and may be supported by at least one (ball) bearing(s) 111. The coupling arrangement 140 may be attached to the tube 121 using a screw 122. Any other types of mechanical attachment such as quick connect, thread connection, flanged connection, compression fitting push-fit, connections grooved connections, etc. The function of the tube 121 is to operate as a drive shaft for the tubular arm as will be explained.

The coupling arrangement 140 may be a substantially L-shaped structure moulded from aluminium or injection moulded plastic in two pieces and mechanically attached together with bolts and nuts.

An actuator, such as an electrical motor 112, may connect directly, through gears or a belt drive to the tube 121 inside the hosing to rotate the tube and thereby the coupling arrangement, hallow tube 121 and the pad 130 around the central longitudinal axis of the tube 121. One end of the tube, inside the housing, connects with a fan 114 or a space housing the fan. In operation, the fan receives a control signal from a controller and generates an air flow by creating a low-pressure area or negative pressure inside the tube 121 and there by a suction effect, due to which air through the hallow tube 120 and apertures on the surface of the pad 130 flow as represented by the arrows 170, through the pad 130, the joint 150, the tubular arm 120, the tube 121, out through a channel 113 in the housing 110, and exit through an exhaust 115 in the housing.

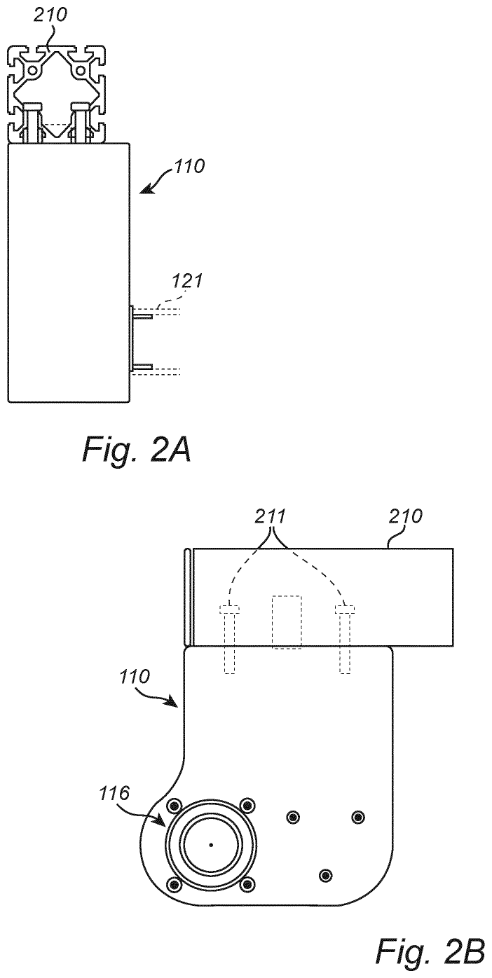

FIGS. 2a and 2b illustrate an exemplary housing 110 from two sides, frontal and side views, respectively. The housing 110 is provided with an opening 116 for receiving the tube 121. The housing is also configured to be mounted on a support arm 210 through attachment means 211, e.g., such screws or quick connection, etc.

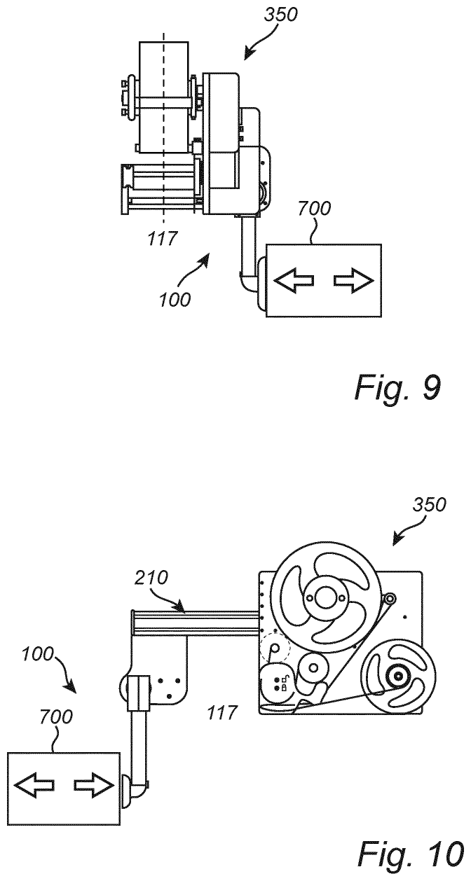

The design of the housing 110 and the tubular arm 120 enables different mounting positions, some of which are exemplified in FIG. 9-14. This can be achieved by, for example, changing one or several of the length of the drive tube 121, the connecting applicator arm 130 as well as some brackets used to hold the housing.

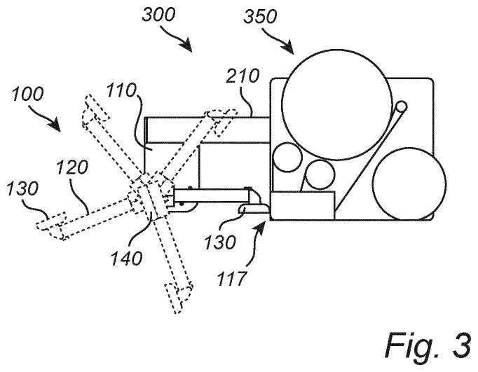

This solution allows the tubular arm 120 and the applicator pad 130 to rotate substantially 360° around the centre axis of the tube 121. This is illustrated in the exemplary print and apply system 300 of FIG. 3. The print and apply system 300 comprises a label printer, e.g., an industrial label printer 350 and the applicator assembly 100 as described previously. Different positions of the pad 130, tubular arm 120 and coupling arrangement 140 are illustrated with dashed lines.

In operation, the label printer 350 feeds a label (not shown in FIG. 3), which is received on the surface of the pad 130 in a receiver position 117. The air suction through the pad surface due to the operation of the fan 114 (FIG. 1) retains the label on the surface of the pad, which can rotate to apply the label on an object (not shown in FIG. 3.)

The arrangement of the present disclosure provides solutions to avoid having several printers, e.g., for right and left hand, provide a solution that can apply the printed labels onto many different sides of an object, and easily combine many versions and combinations of print and apply systems.

According to the present disclosure, due to the ability to rotate arm around its centre axis and along an axis at one end, the applicator system inverts the function of the wipe applicator type in the mounting positions where it would normally is not possible to carry out the label application.

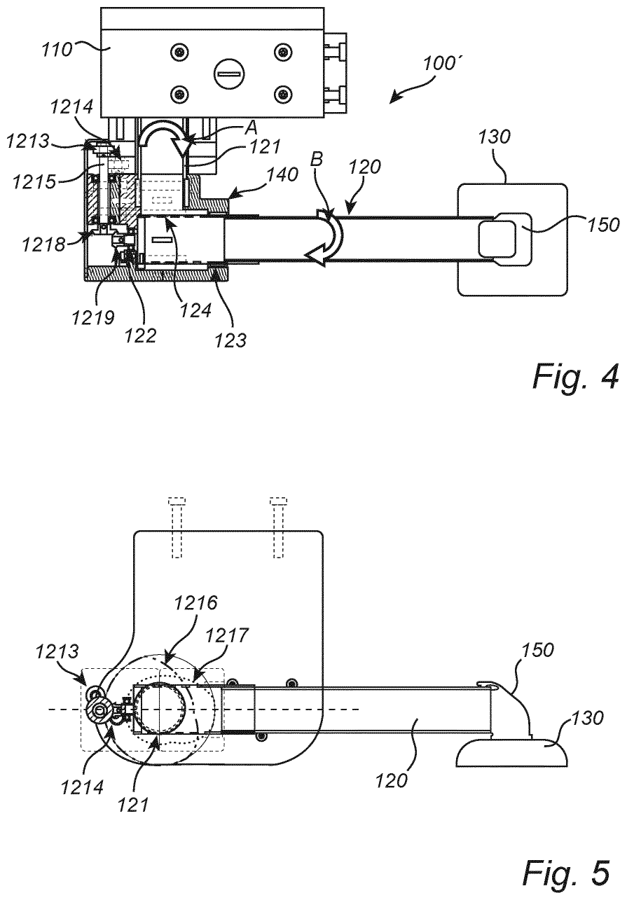

The embodiment disclosed in FIGS. 4 and 5 (respectively view from above and side view) illustrate an exemplary applicator assembly 100′ with additional functionality of the tubular arm 120 being rotatable around its central longitudinal axis. Thus, the tubular arm 120 and the coupling arrangement 140 are rotatable substantially 360° around the central longitudinal axis (rotation A) of the tube 121 and in addition, the tubular arm is rotatable 180° along its central longitudinal axis (rotation B). This feature allows to rotate a label which is held in place on the surface of the applicator pad 130 with its adhesive side faced downwards as seen in FIG. 5, into a different orientation, e.g. to place the adhesive side faced upwards, left or right, before application,

The rotation B may passively be driven by rotation A. The mechanism for rotation B comprises, according to this example, at least two guide wheels: an (first) inner guide wheel 1213 and an (second) outer guide wheel 1214, a guide shaft 1215, guide tracks 1216 and 1217. The guide wheels 1213 and 1214 are connected to the guide shaft 1215. The inner guide wheel 1213 follow the inner guide track 1216 and the outer guide wheel 1214 follow the outer guide track 1216. The two guide wheels ensure that the guide shaft 1215 has a defined angle at all angles of the tube 121. The guide shaft 1215 is connected to an angle gears 1218 and 1219. The angle gears 1218 and 1219 connect to the tubular arm 120. The tubular arm 120 rotates in bearings 122 and 123 fitted in the tube 121 and coupling arrangement 140. The tubular arm may comprise perforations 124 inside the tube 121 and coupling arrangement 140 to allow air there through.

The side view of FIG. 5 shows how the two guide wheels 1213, 1214 follow the two guide tracks and create a fixed rotational pattern that is conveyed by the angle gears to the applicator arm and to the label pad. The label pad can then be at 0° when printing and 180° when applying. It should be noted that the guide tracks may be different for different applications due to the different mounting angles.

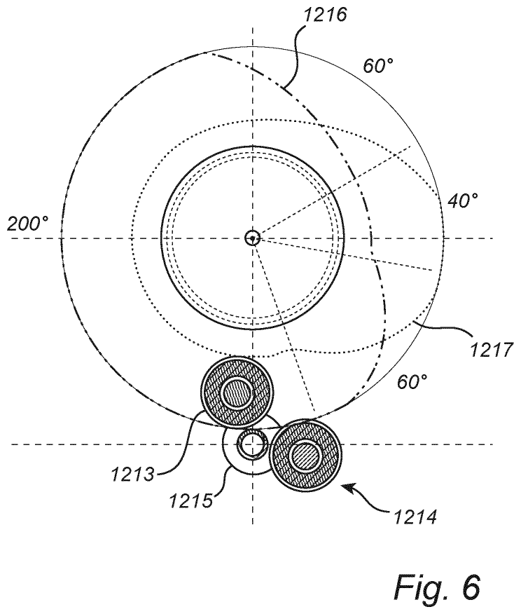

The rotation of the tubular arm around its centre axis is represented in FIG. 6.

The two guide wheels enable that the guide shaft 1215, at every application position, do not deviate from the desired rotation in any direction. FIG. 6 shows that guide wheel 1213 prevents clock wise deviation from the desired position and guide wheel 1214 prevents counter clockwise deviation.

The guide tracks are designed so that the tubular arm 120 can rotate in total substantially 180°. For example, the guide shaft can rotate 90° and the angle gear can have a 1:2 gearing ratio. The guide tracks 1216 and 1217 can also be designed so that rotation B can be at 0° rotation at a print position, meaning the label will be fed onto the label pad with the printed side facing the label pad. The guide tracks are arranged in two different levels and/or two independent guide tracks. One guide track (the outer) may be fixed in the applicator housing. According to this embodiment, rotations are made at ±60°, a normal/print/paper change position may be at 40° and invert/apply at 200°.

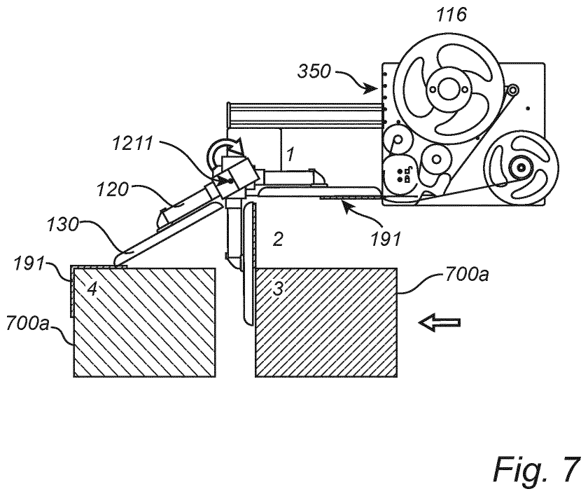

One exemplary operation of the applicator as disclosed above is illustrated in FIG. 7. In the drawings, same applicator arm, i.e., the tubular arm 120 and the pad 130, are shown in several positions.

In position 1: A label printer 350 prints and provides labels 191 on to the applicator pad's 130 surface, which is in a position to receive the label fed out from the printer dispenser portion.

In position 2: the tubular arm 120 is both rotates around centre axis 1211 (of the tubular shaft (121)) as described previously and is also rotated 180° around its own centre axis such that the surface of the applicator pad carrying the label faces an item 700 moving towards (e.g., on a conveyor not shown in FIG. 7) the label applicator's operation area. As rotation around the of the tube increases and the arm approaches the labelling object rotation of the will turn to 180°, this implies that the tubular arm 120 will always be rotated substantially 180° when it is in position to apply a label.

In position 3: the arm 120 is rotated 90° around axis 1211 and 180° around its centre axis such that the applicator pad with label on its faces the approaching item 700a and applies the label 191 on upper corner on a first side of the item 700a.

In position 4: the item 700a continues its travel and the applicator is rotated further around axis 1211 letting the label 191 to continue and be applied on the adjacent surface, in this right side with respect to the travel direction the item 700a.

After application of the label, the arm can move back the same way as it came from or continue one revolution, around both axis 1211 and its centre axis, back to the print at position 1.

Consequently, the assembly as disclosed herein, negates the need for an inverted complete print and apply system including replacing the inversion of a label printer and a complete turning/twisting label applicator. The same sides are possible to label but with a much fewer parts and options to choose from, which simplifies for the customer, simplifies the pre-sales process, reduces the number of inventory items, and reduces the production costs due to increased production volumes.

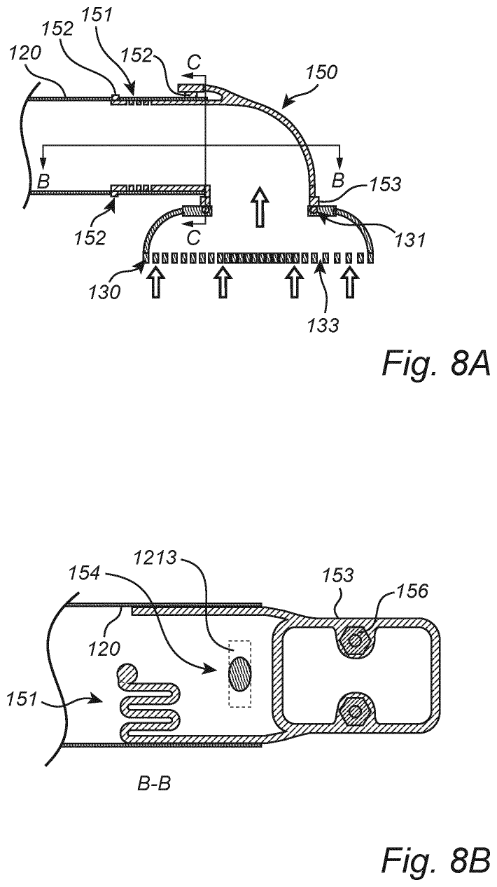

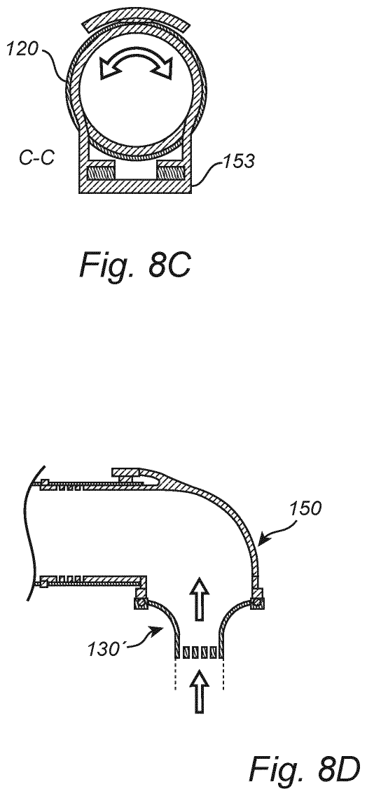

To be able to provide the applicator pad with flexibility during rotations and applications and also be able to apply labels on uneven surfaces, the applicator pad 130 can be connected to the tubular arm 120 by means of a joint 150 or “wrist” as illustrated in FIGS. 8a-8d. FIG. 8a is a cross section of an exemplary joint 150, tubular arm 120 and the applicator pad 130. FIG. 8b is a cross section along line B-B in FIG. 8a. FIG. 8c is a cross section along line C-C in FIG. 8a.

The joint 150 is a tubular body having a substantially L-shape. The joint is at one end inserted inside the tubular arm 120, allowing it to rotate without significant air leakage and at the other end mechanically connected to a base portion of the pad 130. The joint comprises a resilient/springy portion 151, one or more locking latches 152, a connection portion 153 and a guide latch 154.

The locking latches 152 attach to the surrounding tubular arm by snapping into designated holes on the tubular arm. The resilient portion 151 helps to pull the joint back to a home position after a label application. Furthermore, the joint comprises a latch or an extrusion 154 that connects to a track 1213 in the tubular arm 120. In FIG. 8b the guide track 1213 and latch 154 are shown for explanatory reasons and are not along the line B-B. The extrusion combined with the appropriate track length limits the angle of the rotation for the joint and the pad 130, thereby preventing the joint from over twisting. This may also prevent the resilient portion from over extension and following damage. The label applicator pad 130 can be attached directly to the joint's connection portion 153 by for attachment means, such as screws 156 snapped into the joint.

While the joint 150 may have a substantially circular cross section, especially at the portion inserted into the arm, the connection portion 154 to the pad base may be rectangular. However, the form of the joint is not limited to these shapes and may follow the tubular arm and/or pad base connection portion. Sealings 131, such as rubber sealings may be arranged between the pad base and the joint connection portion.

In one embodiment the joint may be 3-D printed, e.g., selective laser printing, in one piece and the resilient portions may comprise an inbuilt 3-d printed spring. The joint may also be made by moulding or casting.

FIG. 8a also shows apertures or holes 133 in the surface of the application pad 130 that receives a label. This configuration is valid for all embodiments.

Consequently, when the tubular arm, for example made of aluminium or carbon fibre, is used to build up the rotating arm, a structure is required between the arm and the applicator pad. By means of 3D-printing in for example SLS which is a non-expensive manufacturing method a reliable joint is provided.

In some exemplary embodiments, by making the joint thinner and weaker than the tubular arm, it may be possible to intentionally make the joint brake before the tube brakes if the label applicator is exposed to an unexpected outside force such as for example a collision. If the joint is easy to replace, then the recovery can be both cheap and easily done.

FIG. 8d illustrates another exemplary joint 150 and pad 130′ configuration for small labels, in which the surface of the pad 130′ is much smaller and comprises a tapered body.

The shape of the joint is not limited to the illustrated and disclosed examples and other shapes and forms may occur depending on the applications. Variants of the solutions could also be used for all mounting positions.

FIGS. 9 to 14 illustrate exemplary print and apply system configurations, with different mounting solutions for the tubular arm. In FIGS. 9-14, a label printer is designated with 350, the applicator system with 100, a support arm 210, 117 is the area for the pad to receive a label and the item to be labelled with 700.

The housing in all mounting positions is arranged so that the outgoing airflow from the fan in the housing is always directed either with the label feeding direction or perpendicular to the right or left compared to the label feeding direction. This means that the fan's outgoing airflow is never directed against the label feeding direction. This prevents the fan's outgoing airflow from generating undesired air turbulation which would work against the label feeding process.

In the following descriptions of FIGS. 9-14, all disclosed directions are with respect to the plane of the drawings. In FIG. 9, the applicator pad receives the label in a horizontal position at 117 and swings from left to right and downwards to apply the label on the item. By rotating the tubular arm 180 degrees two sides of the item 700, in direction of arrows can be applied with labels.

In FIG. 10, the applicator assembly is arranged on the support arm and distanced from the printer. The applicator pad receives the label in a horizontal position at 117 and swings from right to left and downwards to apply the label on the item. By rotating the tubular arm 180 degrees two sides of the item 700, in direction of arrows can be applied with labels.

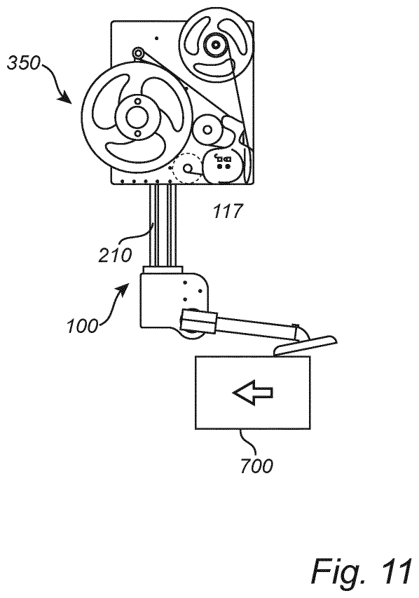

In FIG. 11, the applicator assembly is arranged on the support arm and distanced from the printer. The applicator pad receives the label in a vertical position at 117 and swings from vertical position to right and downwards to apply the label on upper side of the item.

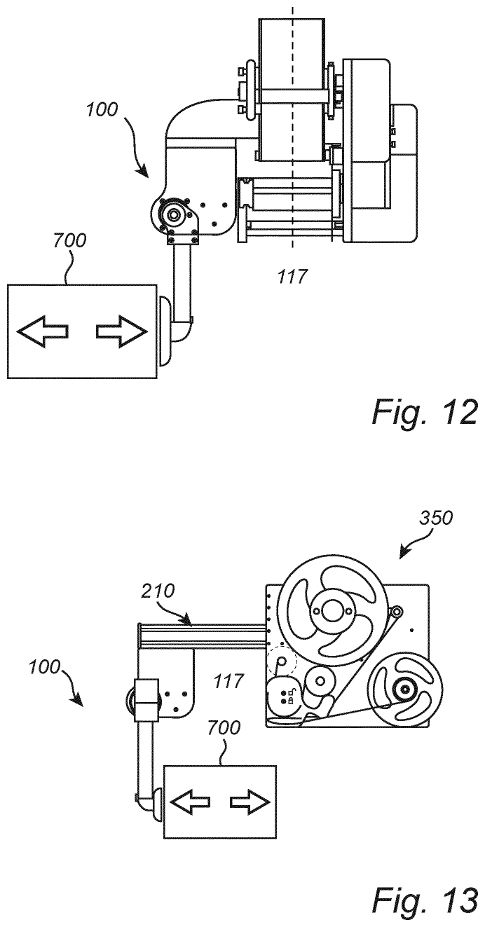

In FIG. 12, the applicator pad receives the label in a horizontal position at 117 and swings from right to left and downwards to apply the label on the item. By rotating the tubular arm 180 degrees two sides of the item 700, in direction of arrows can be applied with labels.

In FIG. 13, the applicator assembly is arranged on the support arm and distanced from the printer. The applicator pad receives the label in a horizontal position at 117 and swings from right to left and downwards and turns 180° to apply the label on the item. By rotating the tubular arm 180°, two sides of the item 700, in direction of arrows can be applied with labels.

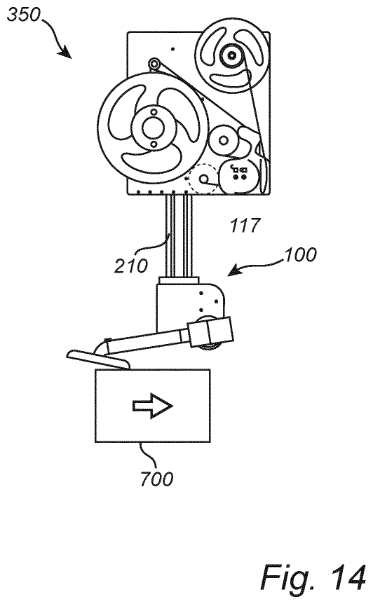

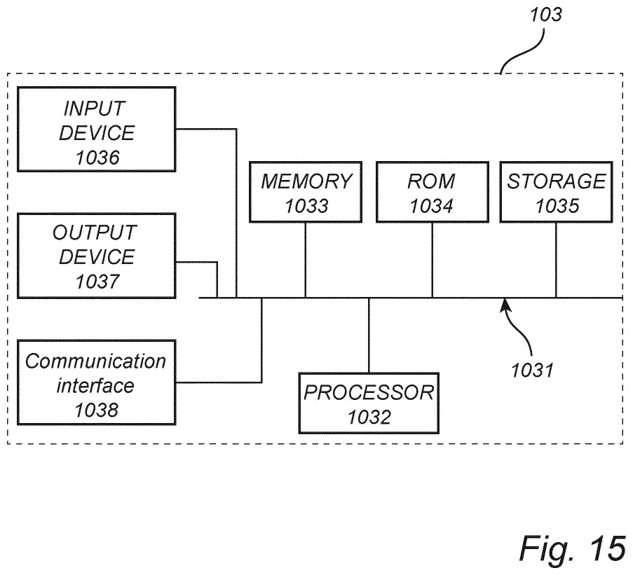

In FIG. 14, showing same setup as FIG. 11, with the arm turned 180 the applicator assembly is arranged on the support arm and distanced from the printer. The applicator pad receives the label in a vertical position at 117 and swings from right to left and downwards to apply the label on the item. It may also swing from left to right and turn the arm 180 degrees to apply the label.

In some exemplary embodiments the tubular arm mechanism may further comprise an adjustable length arm, e.g., a telescopic arm, allowing for variation in the radius of rotation to accommodate different object sizes and label placement requirements.

In some exemplary embodiments sealings, such as O-rings, rubber sealings, etc, may be arranged between different parts from the pad to the fan to avoid air leakage.

The operation of the applicator assembly and the movement of the applicator arm may be controlled by a controller, controlling the driving motors in the housing, receiving sensorial or encoder signals from various sensors or communicate with other devices. The controller may be stand alone or part of the printer controller.

A user interface may be provided in communication with the controller allowing for configuration settings, adjustment of label placement, and monitoring of the label application process.

For these purposes a sensor system may be included in the applicator system, as disclosed, comprising optical sensors, proximity sensors, or combination thereof, providing accurate detection of the object's presence and positioning for efficient label application.

FIG. 15 illustrates schematically an exemplary controller 103. The controller 103 may communicate with various sensors of the printer, such as the encoder for motors 132, 152, 162, and170. The controller may be stand alone or be part of the printer controller as mentioned previously. The controller 103 as described earlier in which methods and systems described herein may be implemented, may include a bus 1310, a processor 1032, a memory 1033, a read only memory (ROM) 1034, a storage device 1350, an input device 1035, an output device 1037, and a communication interface 1038. The bus 1031 permits communication among the components of controller 103. The bus may be any of several types of bus structures that may further interconnect to a memory bus (with or without a memory controller), a peripheral bus, and/or a local bus using any of a variety of bus architectures. The controller 103 may also include one or more power supplies (not shown). One skilled in the art would recognize that controller 103 may be configured in several other ways and may include other or different elements.

The processor 1032 may include any type of processor or microprocessor that interprets and executes instructions. The processor 1032 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor may further include computer executable code that controls operation of the programmable device. The processor 1032 may also include logic that is able to receive and compile instructions and interpret different signal, and also generate output to, for example, a speaker, a display, etc.

The memory 1033 may include a random-access memory (RAM) or another dynamic storage device that stores information and instructions for execution by processor 1032. Memory 1033 may also be used to store temporary variables or other intermediate information during execution of instructions by processor 1032. The memory 1033 may be one or more devices for storing data and/or computer code for completing or facilitating methods described herein. The memory may include database components, object code components, script components, or other types of information structure for supporting the various activities herein. Any distributed or local memory device may be utilized with the systems and methods of this description. The memory may be communicably connected to the processor device (e.g., via a circuit or any other wired, wireless, or network connection) and may include computer code for executing one or more processes described herein. The memory may include non-volatile memory 1034 (e.g., read-only memory (ROM), erasable programmable read-only memory (EPROM), electrically erasable programmable read-only memory (EEPROM), etc.), and volatile memory (e.g., random-access memory (RAM)), or any other medium which can be used to carry or store desired program code in the form of machine-executable instructions or data structures and which can be accessed by a computer or other machine with a processor. A basic input/output system (BIOS) may be stored in the non-volatile memory 1034 and can include the basic routines that help to transfer information between elements within the controller.

ROM 1034 may include a conventional ROM device and/or another static storage device that stores static information and instructions for processor 1032. Storage device 1350 may include a magnetic disk or optical disk and its corresponding drive and/or some other type of magnetic or optical recording medium and its corresponding drive for storing information and instructions. Storage device 1350 may also include a flash memory (e.g., an electrically erasable programmable read only memory (EEPROM)) device for storing information and instructions.

Input device 1035 may include one or more conventional mechanisms that permit a user to input information to the controller 103, such as a keyboard, a keypad, a directional pad, a mouse, a pen, voice recognition, a touch-screen and/or biometric mechanisms, etc. Output device 1037 may include one or more conventional mechanisms that output information to the user, including a display, a printer, one or more speakers, etc. Communication interface 1038 may include any transceiver-like mechanism that enables controller 103 to communicate with other devices and/or systems. For example, communication interface 1038 may include a modem or an Ethernet interface to a LAN. Alternatively, or additionally, communication interface 1038 may include other mechanisms for communicating via a network, such as a wireless network. For example, communication interface may include a radio frequency (RF) transmitter and receiver and one or more antennas for transmitting and receiving RF data.

The controller 103, consistent with the disclosure, provides a platform through which the various functions of applicator stand alone or in combination with a printer are controlled. The controller 103 may also display information associated with the label application status of printer relevant information.

According to an exemplary implementation, controller 103 may perform various processes in response to processor 1032 executing sequences of instructions contained in memory 1033. Such instructions may be read into memory 1033 from another computer-readable medium, such as storage device 1350, or from a separate device via communication interface 1038. It should be understood that a computer-readable medium may include one or more memory devices or carrier waves. Execution of the sequences of instructions contained in memory 1033 causes processor 1032 to perform the acts that have been described. In alternative embodiments, hard-wired circuitry may be used in place of or in combination with software instructions to implement aspects consistent with the disclosure. Thus, the disclosure is not limited to any specific combination of hardware circuitry and software.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the disclosure may be implemented at least in part by means of both hardware and software, and that several “means”, “units” or “devices” may be represented by the same item of hardware.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

Software and web implementations of various embodiments of the disclosed methods can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A labelling machine configured to apply a label on an object, the labelling machine comprising:
an arm mechanism;
a label pad configured to temporarily retain a label, said label pad being attached to a first end of said arm mechanism;
an actuator connected to a first end of said arm mechanism to provide rotational movement of said arm mechanism;
a control system configured to control the movement and position of said arm mechanism and the label pad; and
an air flow generator;
wherein:
the labelling machine further comprises a drive shaft connected to said actuator and configured to be rotated about a longitudinal axis of the drive shaft;
a second end of the arm mechanism is connected to said drive shaft, such that the longitudinal axis of the drive shaft and the arm mechanism are perpendicular to one another; and
an air flow channel extends from the air flow generator via the drive shaft, through the arm mechanism to the label pad.

2. The labelling machine of claim 1, further comprising a housing accommodating the air flow generator.

3. The labelling machine according to claim 2, wherein the housing accommodates the actuator and the drive shaft.

4. The labelling machine according to claim 1, wherein said arm mechanism includes an adjustable length arm, to enable variation in a radius of rotation of the arm mechanism.

5. The labelling machine according to claim 1, wherein the actuator is connected to the arm mechanism to enable rotation of the arm mechanism along a longitudinal axis of the arm mechanism.

6. The labelling machine according to claim 5, wherein a transmission is provided between the actuator and the arm mechanism, said transmission being configured to rotate the arm mechanism along the longitudinal axis of the arm mechanism when the actuator actuates the drive shaft to rotate the arm mechanism about the longitudinal axis of the drive shaft.

7. The labelling machine according to claim 6, wherein the transmission comprises a first guide wheel, a second guide wheel, a guide shaft, a first guide track and a second guide track.

8. The labelling machine according to claim 7, wherein
the first and second guide wheels are connected to the guide shaft;
the first guide wheel is arranged to follow the first guide track and the second guide wheel is arranged to follow the second guide track; and
the first and the second guide wheels are arranged to ensure that the guide shaft has a defined angle at all angles of the drive shaft.

9. The labelling machine according to claim 8, wherein the guide shaft is connected to angle gears and the angle gears are connected to the first end of the arm mechanism.

10. The labelling machine according to claim 9, wherein the first and second guide tracks are configured to enable the arm mechanism to rotate 180° around a longitudinal axis of the arm mechanism.

11. The labelling machine according to claim 9, wherein the guide shaft is arranged to rotate 90° and the angle gears have a 1:2 gearing ratio.

12. (canceled)

13. The labelling machine according to claim 7, wherein the first and second guide tracks are arranged as two independent guide tracks, wherein at least one of the first guide track or the second guide track is connected to the housing to enable the arm mechanism to position the label pad in a label receiving position.

14. (canceled)

15. The labelling machine according to claim 1, further comprising a joint to couple the arm mechanism to the label pad, the joint comprising an L-shaped tubular body.

16. The labelling machine according to claim 15, wherein the joint is configured at one end to be inserted inside the arm mechanism and to rotate without air leakage when received inside the arm mechanism, and a second end of the joint is mechanically connected to a base portion of the label pad.

17. (canceled)

18. The labelling machine according to claim 15, including a resilient portion configured to assist in pulling the joint back to a home position after a label application.

19. The labelling machine according to claim 18, wherein a transmission is provided between the actuator and the arm mechanism, the actuator being connected to the arm mechanism to enable rotation of the arm mechanism along a longitudinal axis of the arm mechanism, the transmission being configured to rotate the arm mechanism along the longitudinal axis of the arm mechanism when the actuator actuates the drive shaft to rotate the arm mechanism about the longitudinal axis of the drive shaft, the transmission comprising a first guide track and a second guide track, and the labelling machine including a latch configured to connect to the first guide track or the second guide track, the latch being configured to limit an angle of the rotation for the joint and to prevent over-extension of the resilient portion.

20. The labelling machine according to claim 18, wherein the joint is 3-D printed in one piece and the resilient portion comprises an inbuilt 3-D printed spring.

21. The labelling machine according to claim 15, wherein the joint is thinner and/or weaker than the arm mechanism.

22. The labelling machine according to claim 15, wherein the joint enables the label pad to follow contours of an object during label application.

23. The labelling machine according to claim 1, further comprising a sensor system configured to provide detection of presence and position of an object.

24. The labelling machine according to claim 1, wherein the drive shaft is configured to rotate 360 degrees around the longitudinal axis of the drive shaft.

25. A print and apply system comprising a label printer and a labelling machine configured to apply a label on an object, the labelling machine comprising:
an arm mechanism:
a label pad configured to temporarily retain a label, said label pad being attached to a first end of said arm mechanism;
an actuator connected to a first end of said arm mechanism to provide rotational movement of said arm mechanism;
a control system configured to control the movement and position of said arm mechanism and the label pad; and
an air flow generator;
wherein:
the labelling machine further comprises a drive shaft connected to said actuator and configured to be rotated about a longitudinal axis of the drive shaft;
a second end of the arm mechanism is connected to said drive shaft, such that the longitudinal axis of the drive shaft and the arm mechanism are perpendicular to one another; and
an air flow channel extends from the air flow generator via the drive shaft, through the arm mechanism to the label pad.
